(19) United States
(12) Patent Application Publication
(10) Pub. No.: US 2014/0008138 A1
(43) Pub. Date: Jan. 9, 2014

(54) Electric Vehicle Driven with Interaction with Rider

(71) Applicants: Joon Hyung Kim, Seoul (KR); Tae Ho Kang, Seoul (KR)

(72) Inventors: Joon Hyung Kim, Seoul (KR); Tae Ho Kang, Seoul (KR)

(73) Assignee: ROBO3 Co.,Ltd., Seoul (KR)

(21) Appl. No.: 13/601,204

(22) Filed: Aug. 31, 2012

(30) Foreign Application Priority Data
Jul. 6, 2012 (KR) 10-2012-0073779

(51) Int. Cl. B62D 51/02; B62D 61/08; B62D 61/02; B62D 61/06

(52) U.S. Cl. 180/216; 180/220

(57) ABSTRACT

An electric vehicle including: an operating shaft inserted into the center of the upper portion of a motor housing and having steering handles mounted on the front end thereof to change the drive direction of the vehicle; motors mounted onto the interiors of both sides of the motor housing and having front wheels coupled correspondingly thereto; a foot board mounted on the rear side of the operating shaft; a battery and a controller mounted on the underside of the foot board; a rear connection member protruded backwardly from the board and having a caster mounted on the underside thereof; and a front connection member protruded forwardly from the foot board, coupled by a connection shaft to foot board shaft holes formed on the lower ends of both sides of the motor housing, in a state of being isolated downwardly.

### CROSS-REFERENCE TO RELATED APPLICATION

This application claims the benefit under 35 U.S.C. §119 of Korean Patent Application No. 10-2012-0073779, filed Jul. 6, 2012, which is hereby incorporated by reference in its entirety.

### BACKGROUND OF THE INVENTION

1. Field of the Invention

The present invention relates to an electric vehicle, and more particularly, to an electric vehicle driven with the interaction with a rider that is capable of performing riding manipulations inclusive of moving forward and backward by pushing an operating shaft taken by the rider in a forward direction to move forward and by pulling the operating shaft in a backward direction to move backward, thereby being driven with the interaction with the rider's arm actions.

2. Background of the Related Art

FIG. 1 is a perspective view showing an upright riding type electric vehicle of the prior art. As shown in FIG. 1, an upright riding type electric vehicle 70 performs riding by in real time maintaining the balancing between two wheels 60 disposed at the left and right sides of a foot board on which a rider stands. So as to maintain the balancing between the wheels 60, that is, a variety of electrical processors inclusive of a Gyro sensor are controlled by a controller 15, thereby performing the riding.

For example, in a state where the rider stands on the foot board 10 of the upright riding type electric vehicle 70, he is positioned on the foot board 10 just above the wheels 60. Like this, in the state where the rider stands on the foot board 10 just above the wheels 60, if he inclines his body forward by a given angle, while taking steering handles 21, his inclination is sensed through the variety of sensors inclusive of the Gyro sensor, and based upon the sensed result, the wheels 60 are activated in the direction of the inclination by a degree where the inclination is removed, so that the overturning of the electric vehicle caused by his inclination can be prevented, thereby allowing the position of the electric vehicle to be compensated to keep safe riding.

Accordingly, the upright riding can be maintained with the two wheels 60, while the balancing state of the two wheels 60 is being not broken. Further, moving forward and backward is possible in accordance with the inclined directions of the rider's body, and pulling the left and right steering handles 21 permits the direction of movement to be changed.

Under the above-mentioned configuration of the upright riding type electric vehicle 70 of the prior art, the rider should incline his body forward and backward in the state of standing on the foot board 10 just above the wheels 60 to perform forwarding and backward riding. However, it is really hard for a beginner to incline his body forward due to his anxiety about falling down and to incline his body backward so as to reduce the speed of the forward riding, and during his practice, he may be a little or seriously injured. During riding, besides, if any of the two wheels 60 is broken and does not work, the electric vehicle may be overturned laterally, which causes safety problems.

On the other hand, since the operating shaft 20 of the upright riding type electric vehicle 70 of the prior art falls down on the ground while the electric vehicle is being not driven, it is inconvenient to hold and lift the operating shaft 20 whenever riding is needed. To prevent the operating shaft 20 from falling down on the ground, further, the wall surface against which the operating shaft 20 leans should be found whenever parking is needed.

### BRIEF SUMMARY

Accordingly, the present invention has been made in view of the above-mentioned problems occurring in the prior art, and it is an object of the present invention to provide an electric vehicle driven with the interaction with a rider wherein a foot board is located at the rear side of a front wheel(s) to enable all riders inclusive of beginners, so that in a state where a rider holes an operating shaft controlling riding, if the rider's arms are stretched forward to push the operating shaft in a forward direction, the riding is performed.

It is another object of the present invention to provide an electric vehicle driven with the interaction with a rider wherein a foot board is located in such a manner as to be isolated downwardly by a given distance from a wheel rotary axis line of a front wheel(s), so that an operating shaft can be maintained in an upright state during parking, without falling down on the ground, thereby making it convenient to perform the parking

To accomplish the above objects, according to a first aspect of the present invention, there is provided an electric vehicle driven with the interaction with a rider, the electric vehicle including: an operating shaft inserted fixedly into the center of the upper portion of a motor housing and having steering handles mounted on the front end thereof to change the drive direction of the electric vehicle; motors mounted onto the interiors of both sides of the motor housing and having front wheels coupled correspondingly thereto; a foot board mounted on the rear side of the operating shaft, on which the rider stands; a battery and a controller mounted on the underside of the foot board; a rear connection member protruded backwardly from the end portion of the foot board and having a caster mounted on the underside thereof; and a front connection member protruded forwardly from the foot board in such a manner as to be coupled to foot board shaft holes formed on the lower ends of both sides of the motor housing by means of a connection shaft, in a state of being isolated downwardly by a given distance from the wheel rotary axis line of the front wheels.

To accomplish the above objects, according to a second aspect of the present invention, there is provided an electric vehicle driven with the interaction with a rider, the electric vehicle including: a front wheel mounted onto wheel shaft holes formed on the lower ends of a first stand by means of a rotary shaft; the first stand located inside a second stand; an operating shaft having a grasping handle disposed on the front end thereof and adapted to be passed through an insertion hole formed on the top portion of the second stand in such a manner as to be fixed to an assembling hole formed on the top portion of the first stand located inside the second stand; a foot board mounted on the rear side of the operating shaft, on which the rider stands; a battery and a controller mounted on the underside of the foot board; a rear connection member protruded backwardly from the end portion of the foot board; motors mounted onto both sides of the rear connection member to drive rear wheels; and a front connection member formed on the front end of the foot board in such a manner as to be fitted to foot board shaft holes formed on the second stand by means of a connection shaft, in a state of being isolated downwardly by a given distance from a wheel rotary axis line of the front wheel.

To accomplish the above objects, according to a third aspect of the present invention, there is provided an electric vehicle driven with the interaction with a rider, the electric vehicle including: a front wheel in which a motor is embedded mounted onto wheel shaft holes formed on the lower ends of a first stand by means of a rotary shaft; the first stand located inside a second stand; an operating shaft having a grasping handle disposed on the front end thereof and adapted to be passed through an insertion hole formed on the top portion of the second stand in such a manner as to be fixed to an assembling hole formed on the top portion of the first stand located inside the second stand; a foot board mounted on the rear side of the operating shaft, on which the rider stands; a battery and a controller mounted on the underside of the foot board; a rear connection member protruded backwardly from the end portion of the foot board and having a rear wheel mounted thereon; and a front connection member formed on the front end of the foot board in such a manner as to be fitted to foot board shaft holes formed on the second stand by means of a connection shaft, in a state of being isolated downwardly by a given distance from a wheel rotary axis line of the front wheel.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view showing an upright riding type electric vehicle of the prior art;

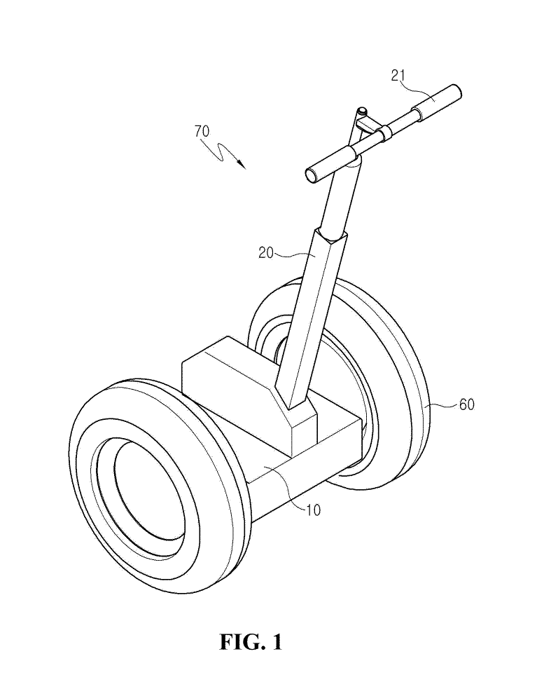

FIG. 2 is a separate perspective view showing an electric vehicle driven with the interaction with a rider according to a first embodiment of the present invention;

FIG. 3 is a separate perspective view showing a wheel rotary axis line and a foot board connection shaft line of the electric vehicle according to the first embodiment of the present invention;

FIGS. 4a and 4b are side views showing the correlation with the wheel rotary axis line and the foot board connection shaft line of the electric vehicle according to the first embodiment of the present invention;

FIG. 5 is a side view showing the direction of the gravity during driving on an inclined ground surface of the electric vehicle according to the first embodiment of the present invention;

FIG. 6 is a perspective view showing the assembled state of the electric vehicle according to the first embodiment of the present invention;

FIG. 7 is a separate perspective view showing an electric vehicle driven with the interaction with a rider according to a second embodiment of the present invention;

FIG. 8 is a separate perspective view showing an operating shaft of the electric vehicle according to the second embodiment of the present invention;

FIG. 9 is a front view showing a wheel rotary axis line and a foot board connection shaft line of the electric vehicle according to the second embodiment of the present invention;

FIG. 10 is a perspective view showing the assembled state of the electric vehicle according to the second embodiment of the present invention;

FIG. 11 is a separate perspective view showing an electric vehicle driven with the interaction with a rider according to a third embodiment of the present invention;

FIG. 12 is a separate perspective view showing an operating shaft of the electric vehicle according to the third embodiment of the present invention;

FIG. 13 is a front view showing a wheel rotary axis line and a foot board connection shaft line of the electric vehicle according to the third embodiment of the present invention; and

FIG. 14 is a perspective view showing the assembled state of the electric vehicle according to the third embodiment of the present invention.

### DETAILED DESCRIPTION

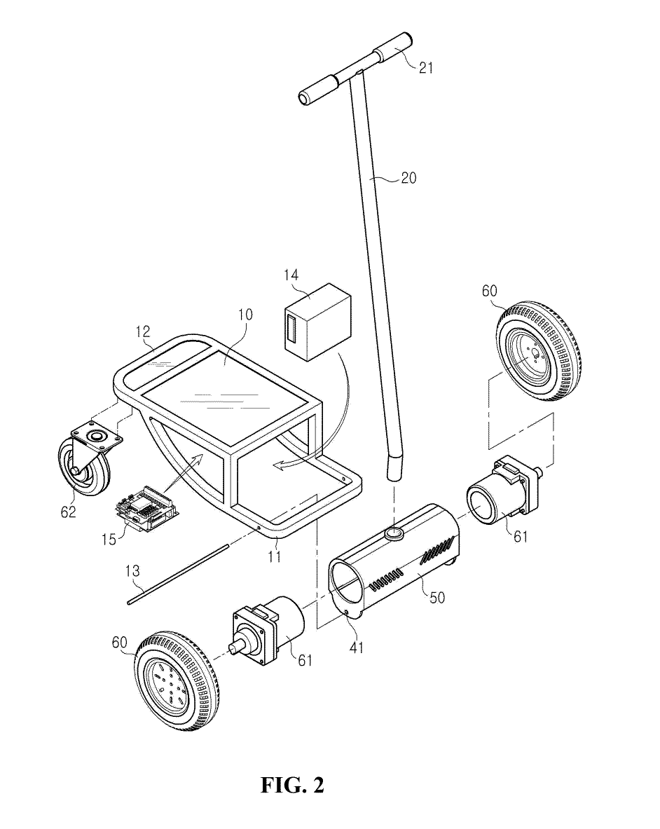

Hereinafter, an explanation on an electric vehicle driven with the interaction with a rider according to first to third embodiments of the present invention will be in detail given with reference to FIGS. 2 to 14. The principles and structures applied in the same manner as each other to the first to third embodiments of the present invention will be suggested generally in the description of the first embodiment of the present invention.

FIG. 2 is a separate perspective view showing an electric vehicle driven with the interaction with a rider according to a first embodiment of the present invention, and as shown in FIG. 2, an operating shaft 20 is rigidly inserted fixedly into the center of the upper portion of a motor housing 50, and steering handles 21 are mounted correspondingly on the left and right sides of the front end of the operating shaft 20 to change the drive direction of the electric vehicle.

Motors 61 are mounted onto the interiors of both sides of the motor housing 50 to drive wheels 60 coupled thereto, and the wheels 60 are rotatably coupled to the shafts of the motors 61. On the other hand, a foot board 10 is mounted on the rear side of the operating shaft 20, on which a rider stands, and a battery 14 is mounted on the underside of the foot board 10 to supply power to the motors 61. Further, a controller 15 on which various sensors inclusive of a Gyro sensor are mounted is disposed on the underside of the foot board 10 to control the drive of the electric vehicle and the change of direction of the electric vehicle. Additionally, the foot board 10 has a rear connection member 12 protruded backwardly from the end portion thereof, and the rear connection member 12 has a freely rotatable caster 62 mounted on the underside thereof.

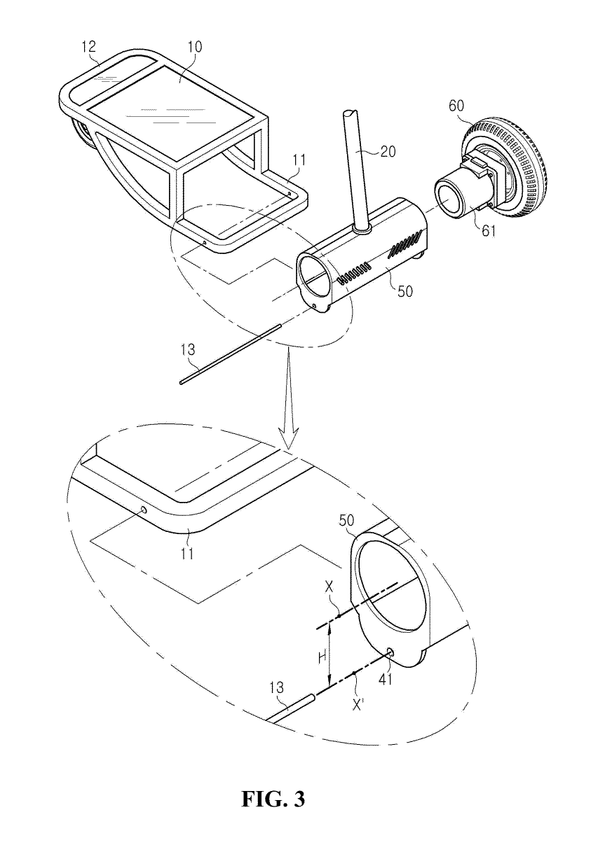

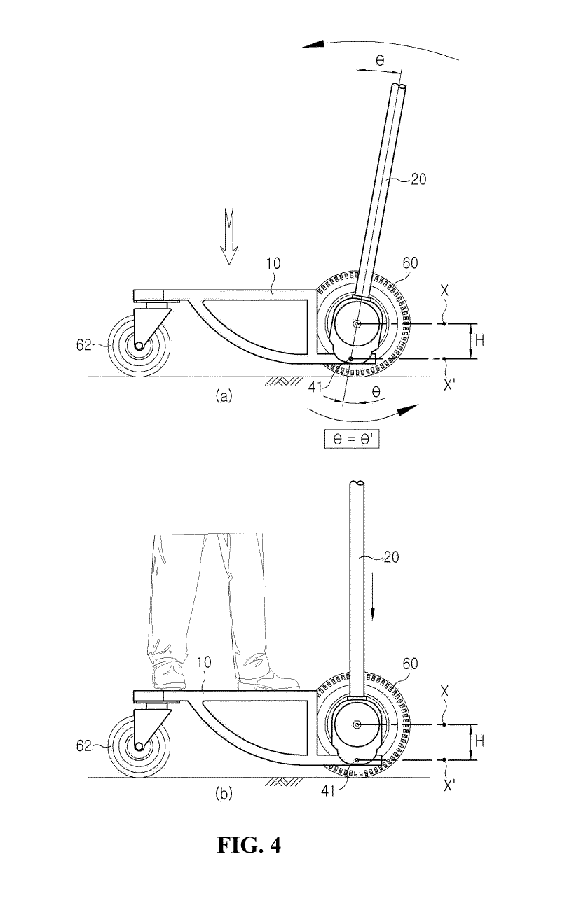

FIG. 3 is a separate perspective view showing a wheel rotary axis line and a foot board connection shaft line of the electric vehicle according to the first embodiment of the present invention, and FIGS. 4a and 4b are side views showing the correlation with the wheel rotary axis line and the foot board connection shaft line of the electric vehicle according to the first embodiment of the present invention. As shown in FIG. 3, the wheels 60 are connected to the shafts of the motors 61, and the motors 61 are inserted into the motor housing 50. Moreover, as shown in the enlarged circle of FIG. 3, a front connection member 11 protruded forwardly from the foot board 10 is coupled to foot board shaft holes 41 formed on the lower ends of both sides of the motor housing 50 by means of a connection shaft 13. As a result, the front connection member 11 of the foot board 10 is coupled to the motor housing 50 in a state of being isolated downwardly by a given distance H from the wheel rotary axis line X, as shown in the enlarged circle of FIG. 3.

As mentioned above, the foot board 10 is coupled to the motor housing 50 by means of the formation of the front connection member 11 below the wheel rotary axis line X of the wheels 60, so that the operating shaft 20 can be maintained in an upright state during parking, without falling down on the ground. That is, FIG. 4a shows a side view of the electric vehicle according to the first embodiment of the present invention during parking, wherein generally, the operating shaft 20 rigidly fixed to the motor housing 50 is turned in a forward direction around the wheel rotary axis line X and is likely to fall down on the ground by means of its self-weight. According to the present invention, however, as braking is carried out by means of the front connection member 11 of the foot board 10 coupled through the connection shaft 13 to the foot board shaft holes 41 formed on the lower ends of the motor housing 50, the rotary force of the operating shaft 20 to fall down on the ground is offset such that the operating shaft 20 is maintained to a state of being inclined forwardly by a first angle θ. Accordingly, the operating shaft 20 can be maintained in an upright state, during parking, without falling down on the ground, thereby making it convenient to park the electric vehicle.

While the operating shaft 20 is being maintained to the state of being inclined forwardly by the first angle θ during parking, on the other hand, if a rider stands on the foot board 10 for riding, as shown in FIG. 4a, load is applied to the foot board 10 in the direction of gravity. At this time, the front connection member 11 of the foot board 10 is turned counterclockwisely and moved by a second angle θ′ around the wheel rotary axis line X, so that the operating shaft 20 is turned counterclockwisely by the first angle θ and becomes thus upright in the direction of gravity, thereby making it convenient to hold the operating shaft 20 by the rider.

Accordingly, after the application of power in the state of FIG. 4b, the steering handles 21 of the operating shaft 20 are taken by the rider, and next, if the operating shaft 20 is pushed forwardly, the operating shaft 20 located to correspond to the direction of gravity is turned around the wheel rotary axis line X and is escaped from the direction of gravity, thereby being inclined forwardly. At this time, the inclination of the operating shaft 20 is sensed by the controller 15 controlling the various sensors inclusive of the Gyro sensor, thereby permitting the motors 61 to be rotated to remove the inclination of the operating shaft 20. Thus, the wheels 60 are driven in the direction of the inclination of the operating shaft 20, thereby making the position of the electric vehicle corrected to perform riding. On the other hand, if the operating shaft 20 is pulled toward the rider's chest, the riding speed becomes decreased, and if his arms holding the operating shaft 20 are more pulled toward his chest to cause the inclination of the operating shaft 20 to be generated toward the rider, the electric vehicle moves backward.

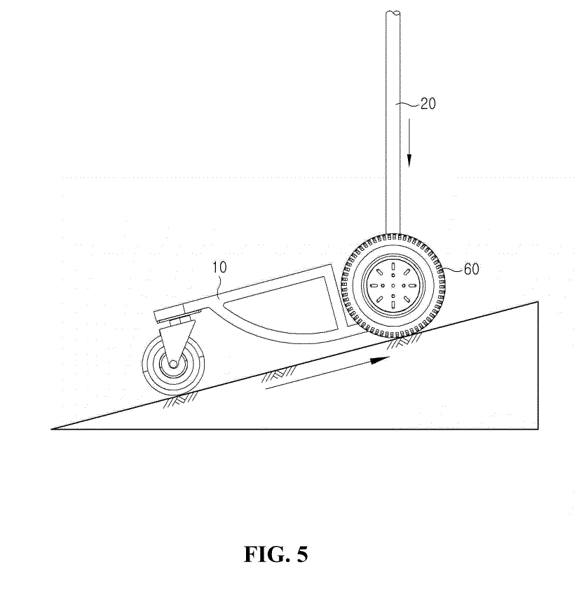

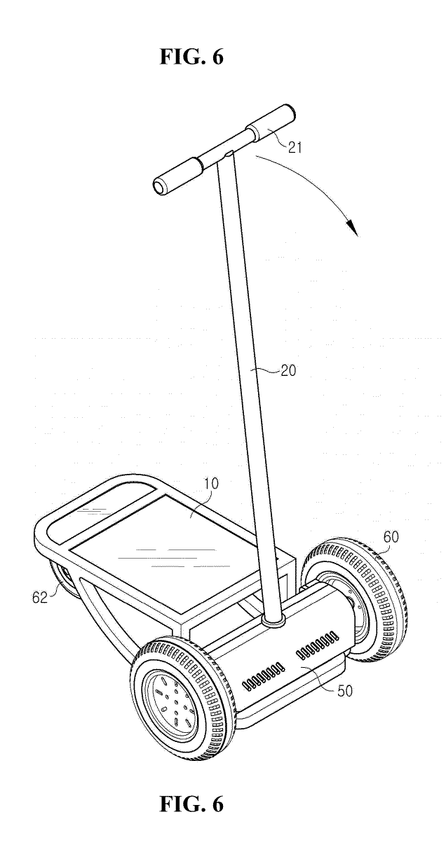

FIG. 5 is a side view showing the direction of the gravity during driving on an inclined ground surface of the electric vehicle according to the first embodiment of the present invention, and FIG. 6 is a perspective view showing the assembled state of the electric vehicle according to the first embodiment of the present invention. As mentioned in FIG. 4b before, if the rider stands on the foot board 10, the operating shaft 20 is located to correspond to the direction of gravity. This time becomes a neutral state where the electric vehicle is maintained at its original position. Through the rider's interaction with the electric vehicle by the check through the rider's eyes and by sensing his posture taking the operating shaft, it is easily checked whether the operating shaft 20 is located to correspond to the direction of gravity or escaped therefrom.

Accordingly, on the flat ground surface as shown in FIG. 4b, the operating shaft 20 is escaped from the direction of gravity through the rider's sense obtained by the interaction with the electric vehicle, thereby allowing the electric vehicle to move forwardly or backwardly. On the other hand, if the electric vehicle is driven on the inclined ground surface as shown in FIG. 5, the operating shaft 20, which is located to correspond to the direction of gravity at the neutral state, is escaped from the direction of gravity in the same manner as on the flat ground surface. Accordingly, the electric vehicle according to the present invention is driven by permitting the operating shaft 20 located toward the direction of gravity to be escaped from the direction of gravity, which is applied to both of the flat ground and the inclined ground.

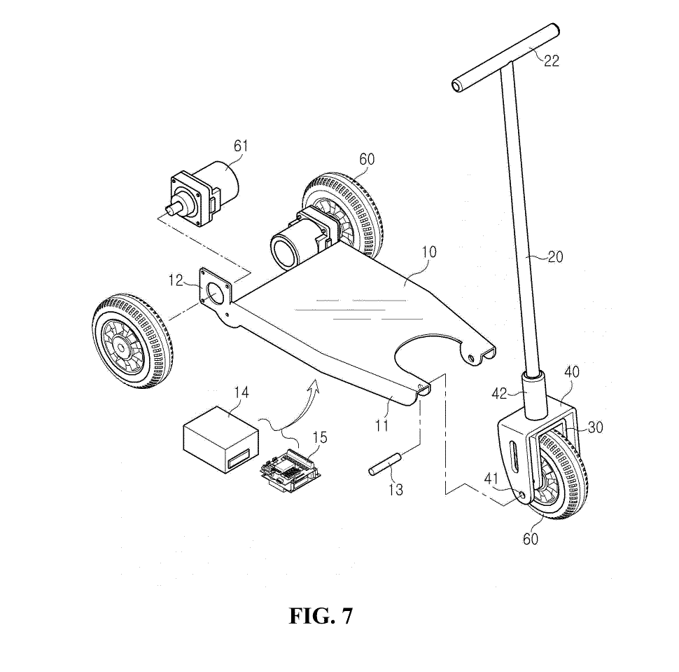

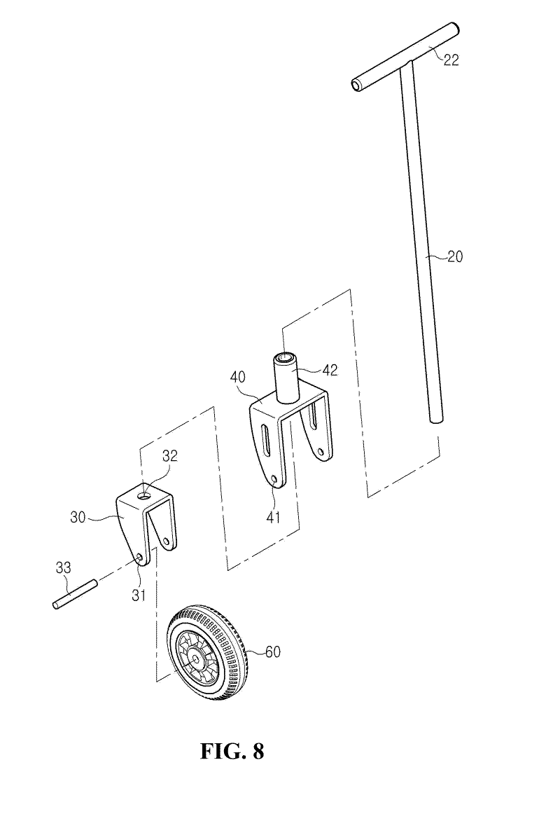

FIG. 7 is a separate perspective view showing an electric vehicle driven with the interaction with a rider according to a second embodiment of the present invention, and FIG. 8 is a separate perspective view showing an operating shaft of the electric vehicle according to the second embodiment of the present invention. As shown in FIGS. 7 and 8, a front wheel 60 is mounted onto wheel shaft holes 31 formed on the lower ends of a first stand 30 by means of a rotary shaft 33, and the first stand 30 is located inside a second stand 40. An operating shaft 20 is passed through an insertion hole 42 formed on the top portion of the second stand 40 and is rigidly fixed to an assembling hole 32 formed on the top portion of the first stand 30 located inside the second stand 40.

Further, as shown in FIG. 7, a foot board 10 is mounted at the rear side of the operating shaft 20, on which the rider stands, and a battery 14 is mounted on the underside of the foot board 10 to supply power to motors 61. Further, a controller 15 on which various sensors inclusive of a Gyro sensor are mounted is disposed on the underside of the foot board 10 to control the drive of the electric vehicle. Additionally, the foot board 10 has rear connection members 12 protruded backwardly from both ends thereof, and the rear connection members 12 have the motors 61 mounted thereon to drive rear wheels 60.

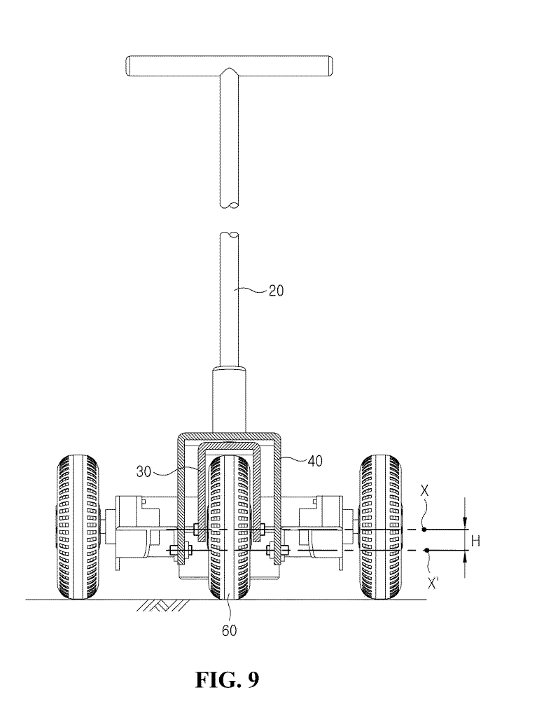

FIG. 9 is a front view showing a wheel rotary axis line and a foot board connection shaft line of the electric vehicle according to the second embodiment of the present invention, and as shown in FIGS. 7 and 9, a front connection member 11 formed on the front end of the foot board 10 is fitted to foot board shaft holes 41 formed on the second stand 40 by means of a connection shaft 13, and in this case, the front connection member 11 is isolated downwardly by a given distance H from a wheel rotary axis line X as the center of the front wheel 60.

Accordingly, as shown in FIG. 9, a foot board connection shaft line X′ of the foot board 10 is set lower than the wheel rotary axis line X of the front wheel 60 by means of the front connection member 11, so that the operating shaft 20 in the electric vehicle according to the second embodiment of the present invention can be maintained in an upright state during parking, without falling down on the ground. This principle has been mentioned in the first embodiment of the present invention, and for the brevity of the description, therefore, the detailed explanation will be avoided.

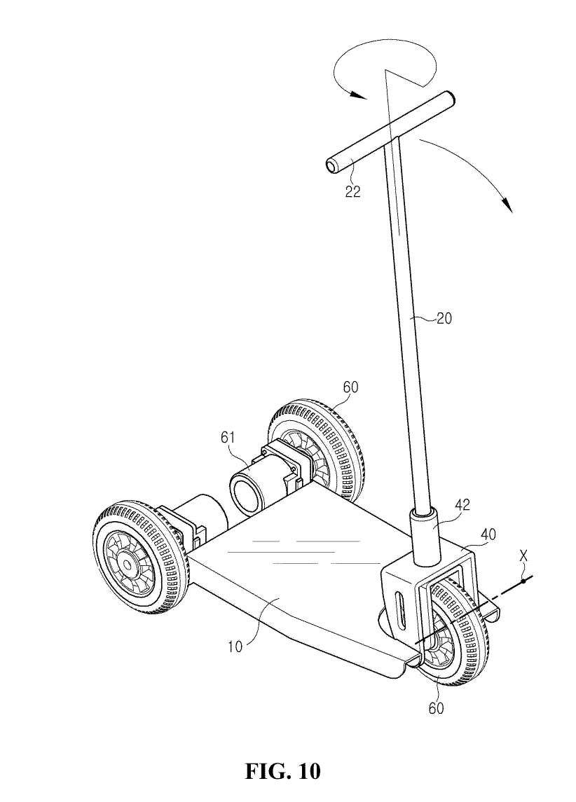

FIG. 10 is a perspective view showing the assembled state of the electric vehicle according to the second embodiment of the present invention. If a rider stands on the foot board 10, the operating shaft 20 is located to correspond to the direction of gravity in the same manner as in the first embodiment of the present invention. Accordingly, after the application of power, a grasping handle 22 of the operating shaft 20 is taken by the rider, and next, if the operating shaft 20 is pushed forwardly, the operating shaft 20 located to correspond to the direction of gravity is turned around the wheel rotary axis line X and is escaped from the direction of gravity, thereby being inclined forwardly.

At this time, the inclination of the operating shaft 20 is sensed by the controller 15 controlling the various sensors inclusive of the Gyro sensor, thereby permitting the motors 61 to be rotated to remove the inclination of the operating shaft 20. Thus, the wheel 60 is driven in the direction of the inclination of the operating shaft 20, thereby making the position of the electric vehicle corrected to perform the riding. On the other hand, if the operating shaft 20 is pulled toward the rider's chest, the riding speed becomes decreased, and if his arms holding the operating shaft 20 are more pulled toward his chest to cause the inclination of the operating shaft 20 to be generated toward the rider, the electric vehicle backs out.

Further, if it is desired to change the direction of the electric vehicle, the operating shaft 20 is turned to the left and right sides around the insertion hole 42 in a simple manner, as shown in FIG. 10. On the other hand, the principle of the riding on the inclined ground of the electric vehicle according to the second embodiment of the present invention is the same as that according to the first embodiment of the present invention, and for the brevity of the description, therefore, the detailed explanation will be avoided.

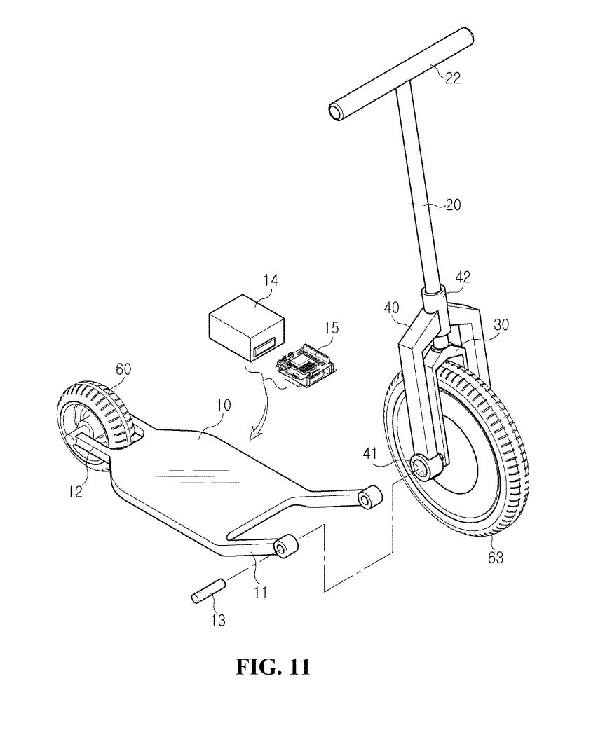

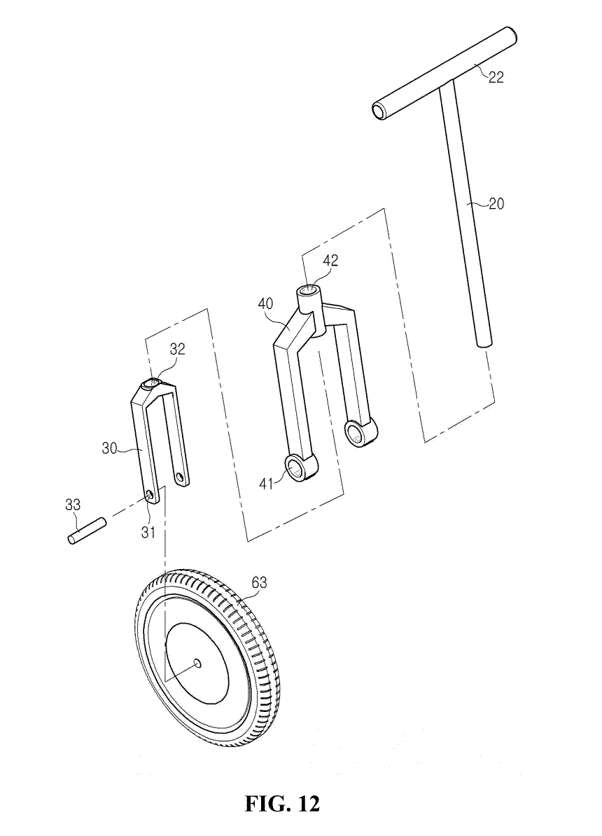

FIG. 11 is a separate perspective view showing an electric vehicle driven with the interaction with a rider according to a third embodiment of the present invention, and FIG. 12 is a separate perspective view showing an operating shaft of the electric vehicle according to the third embodiment of the present invention. As shown in FIGS. 11 and 12, a front wheel 63 in which a motor is embedded is mounted onto wheel shaft holes 31 formed on the lower ends of a first stand 30 by means of a rotary shaft 33, and the first stand 30 is located inside a second stand 40. An operating shaft 20 is passed through an insertion hole 42 formed on the top portion of the second stand 40 and is rigidly fixed to an assembling hole 32 formed on the top portion of the first stand 30 located inside the second stand 40.

Further, as shown in FIG. 11, a foot board 10 is mounted at the rear side of the operating shaft 20, on which the rider stands, and a battery 14 is mounted on the underside of the foot board 10 to supply power to the motor. Further, a controller 15 on which various sensors inclusive of a Gyro sensor are mounted is disposed on the underside of the foot board 10 to control the drive of the electric vehicle. Additionally, the foot board 10 has a rear connection member 12 protruded backwardly from the end thereof, and the rear connection member 12 has a rear wheel 60 mounted thereon.

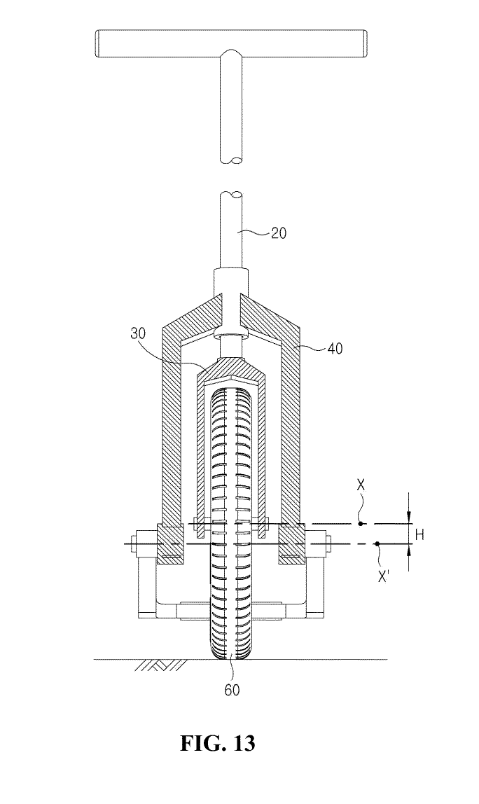

FIG. 13 is a front view showing a wheel rotary axis line and a foot board connection shaft line of the electric vehicle according to the third embodiment of the present invention, and as shown in FIGS. 11 and 13, a front connection member 11 formed on the front end of the foot board 10 is fitted to foot board shaft holes 41 formed on the second stand 40 by means of a connection shaft 13, and in this case, the front connection member 11 is isolated downwardly by a given distance H from a wheel rotary axis line X as the center of the front wheel 60.

Accordingly, as shown in FIG. 13, a foot board connection shaft line X′ of the foot board 10 is set lower than the wheel rotary axis line X of the front wheel 63 by means of the front connection member 11, so that the operating shaft 20 in the electric vehicle according to the third embodiment of the present invention can be upright during parking, without falling down on the ground. This principle has been mentioned in the third embodiment of the present invention, and for the brevity of the description, therefore, the detailed explanation will be avoided.

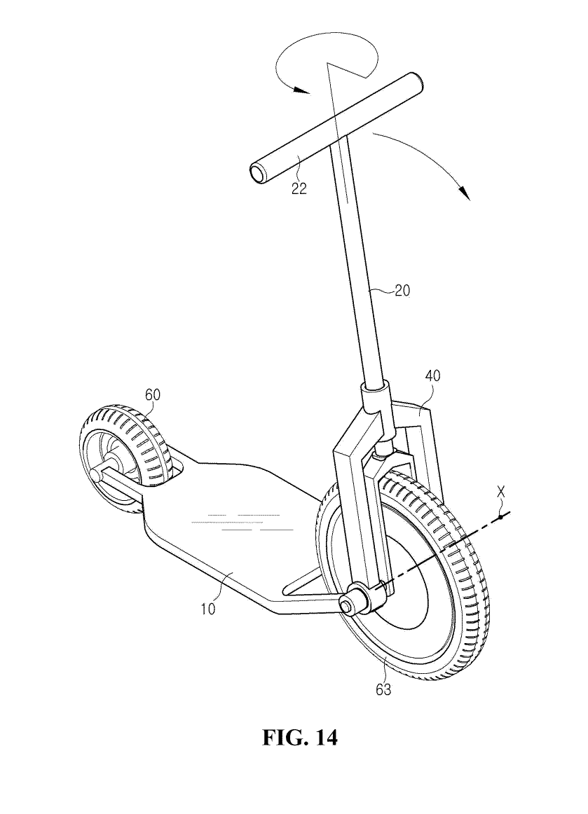

FIG. 14 is a perspective view showing the assembled state of the electric vehicle according to the third embodiment of the present invention. If a rider stands on the foot board 10, the operating shaft 20 is located to correspond to the direction of gravity. Accordingly, after the application of power, a grasping handle 22 of the operating shaft 20 is taken by the rider, and next, if the operating shaft 20 is pushed forwardly, the operating shaft 20 disposed to correspond to the direction of gravity is turned around the wheel rotary axis line X and is escaped from the direction of gravity, thereby being inclined forwardly.

At this time, the inclination of the operating shaft 20 is sensed by the controller 15 controlling the various sensors inclusive of the Gyro sensor, thereby permitting the motor to be rotated to remove the inclination of the operating shaft 20. Thus, the front wheel 63 is driven in the direction of the inclination of the operating shaft 20, thereby making the position of the electric vehicle corrected to perform the riding. On the other hand, if the operating shaft 20 is pulled toward the rider's chest, the riding speed becomes decreased, and if his arms holding the operating shaft 20 are more pulled toward his chest to cause the inclination of the operating shaft 20 to be generated toward the rider, the electric vehicle moves backward.

Further, if it is desired to change the direction of the electric vehicle, the operating shaft 20 is turned to the left and right sides around the insertion hole 42, as shown in FIG. 14, thereby achieving the change of the drive direction through simple manipulations. On the other hand, the principle of the riding on the inclined ground surface of the electric vehicle according to the third embodiment of the present invention is the same as that according to the first embodiment of the present invention, and for the brevity of the description, therefore, the detailed explanation will be avoided.

As set forth in the foregoing, according to the preferred embodiments of the present invention, the electric vehicle driven with the interaction with a rider is configured wherein the foot board is connected at the front end thereof to the front wheel(s), while being isolated downwardly by the given distance H from the wheel rotary axis line X, so that if the rider stands on the foot board, the operating shaft is always located to correspond to the direction of gravity, and therefore, the operating shaft located toward the direction of gravity is checked by the rider's eyes to easily recognize the neutral state of the electric vehicle.

Furthermore, checking whether the operating shaft 20 is located to correspond to the direction of gravity or escaped therefrom is related directly to the driving of the electric vehicle, and therefore, the electric vehicle can be driven through the rider's interaction therewith by the check through the rider's eyes and by sensing his posture taking the operating shaft. As a result, the rider can drive the electric vehicle with the unified feeling with the electric vehicle, thereby conducting stable riding.

According to the present invention, additionally, the foot board is located in such a manner as to be isolated downwardly by the given distance H from the wheel rotary axis line X of the front wheel(s), so that the operating shaft can be maintained in an upright state during parking, without falling down on the ground, thereby making it convenient to perform the parking

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An electric vehicle driven with the interaction with a rider, comprising:
an operating shaft 20 inserted fixedly into the center of the upper portion of a motor housing 50 and having steering handles 21 mounted on the front end thereof to change the drive direction of the electric vehicle;
motors 61 mounted onto the interiors of both sides of the motor housing 50 and having front wheels 60 coupled correspondingly thereto;
a foot board 10 mounted on the rear side of the operating shaft 20, on which the rider stands;
a battery 14 and a controller 15 mounted on the underside of the foot board 10;
a rear connection member 12 protruded backwardly from the end portion of the foot board 10 and having a caster 62 mounted on the underside thereof; and
a front connection member 11 protruded forwardly from the foot board 10 in such a manner as to be coupled to foot board shaft holes 41 formed on the lower ends of both sides of the motor housing 50 by means of a connection shaft 13, in a state of being isolated downwardly by a given distance H from the wheel rotary axis line X of the front wheels 60.

2. An electric vehicle driven with the interaction with a rider, comprising:
a front wheel 60 mounted onto wheel shaft holes 31 formed on the lower ends of a first stand 30 by means of a rotary shaft 33;
the first stand 30 located inside a second stand 40;
an operating shaft 20 having a grasping handle 22 disposed on the front end thereof and adapted to be passed through an insertion hole 42 formed on the top portion of the second stand 40 in such a manner as to be fixed to an assembling hole 32 formed on the top portion of the first stand 30 located inside the second stand 40;
a foot board 10 mounted on the rear side of the operating shaft 20, on which the rider stands;
a battery 14 and a controller 15 mounted on the underside of the foot board 10;
a rear connection member 12 protruded backwardly from the end portion of the foot board 10;
motors 61 mounted onto both sides of the rear connection member 12 to drive rear wheels 60; and
a front connection member 11 formed on the front end of the foot board 10 in such a manner as to be fitted to foot board shaft holes 41 formed on the second stand 40 by means of a connection shaft 13, in a state of being isolated downwardly by a given distance H from a wheel rotary axis line X of the front wheel 60.

3. An electric vehicle driven with the interaction with a rider, comprising:
a front wheel 63 in which a motor is embedded mounted onto wheel shaft holes 31 formed on the lower ends of a first stand 30 by means of a rotary shaft 33;
the first stand 30 located inside a second stand 40;
an operating shaft 20 having a grasping handle 22 disposed on the front end thereof and adapted to be passed through an insertion hole 42 formed on the top portion of the second stand 40 in such a manner as to be fixed to an assembling hole 32 formed on the top portion of the first stand 30 located inside the second stand 40;
a foot board 10 mounted on the rear side of the operating shaft 20, on which the rider stands;
a battery 14 and a controller 15 mounted on the underside of the foot board 10;
a rear connection member 12 protruded backwardly from the end portion of the foot board 10 and having a rear wheel 60 mounted thereon; and
a front connection member 11 formed on the front end of the foot board 10 in such a manner as to be fitted to foot board shaft holes 41 formed on the second stand 40 by means of a connection shaft 13, in a state of being isolated downwardly by a given distance H from a wheel rotary axis line X of the front wheel 63.
